(19) United States
(12) Patent Application Publication
(10) Pub. No.: US 2024/0049265 A1
(43) Pub. Date: Feb. 8, 2024

(54) USER EQUIPMENT AND RESOURCE ALLOCATION METHOD IN SIDELINK COMMUNICATION

(71) Applicant: GUANGDONG OPPO MOBILE TELECOMMUNICATIONS CORP., LTD., Dongguan (CN)

(72) Inventor: Huei-Ming LIN, Taipei (TW)

(21) Appl. No.: 18/382,594

(22) Filed: Oct. 23, 2023

Related U.S. Application Data
(63) Continuation of application No. PCT/CN2022/108757, filed on Jul. 28, 2022.
(60) Provisional application No. 63/228,494, filed on Aug. 2, 2021.

(51) Int. Cl. H04W 72/40; H04W 72/541

(52) U.S. Cl. CPC H04W 72/40; H04W 72/541

(57) ABSTRACT

A user equipment (UE) and a resource allocation method in sidelink communication are provided. The resource allocation method in sidelink communication by the UE includes determining, by a physical layer of the UE, a resource selection window in a sidelink resource pool, determining, by the physical layer of the UE, a contiguous partial sensing window, and switching, by the physical layer of the UE, a resource allocation in the sidelink resource pool between a contiguous partial sensing and a random-based resource selection.

### CROSS-REFERENCE TO RELATED APPLICATIONS

This application is a continuation of International Application No. PCT/CN2022/108757 filed on Jul. 28, 2022, which claims the benefit of priority to U.S. Patent Application No. 63/228,494, filed on Aug. 2, 2021. The contents of the prior applications are hereby incorporated by reference in their entireties.

### BACKGROUND OF DISCLOSURE

### Description of the Related Art

In the development of 5th generation-new radio (5G-NR) based sidelink communication system, the radio technology was primarily designed to support autonomous driving, vehicle platooning and extended sensor sharing use cases in advanced vehicle-to-everything (V2X) communication, and for which a communicating user equipment (UE) can assume to have unlimited supply of electrical power (i.e., connected to vehicle's battery).

The main trigger for a UE to perform partial sensing/monitoring of a SL channel can be based on its need to transmit a data message over the SL. In some cases, however, due to unpredictable resource (re-)selection trigger timing from a certain type of SL traffic, operating scenario and resource re-selection triggering conditions, the UE is unable to perform monitoring of SL resource usage and obtain resource reservation information in advanced to gain sufficient pre-sensing results from partial sensing schemes such as periodic-based partial sensing and contiguous partial sensing. Without these pre-sensing results, the UE may be subsequently unable to detect and determine which of future SL resources that have already been periodically or dynamically reserved by other UEs. If a transmission (Tx) UE mistakenly selects a SL resource that has already been reserved but undetected by the Tx UE, SL transmission using the selected resource may cause a Tx collision with the UE that reserved this resource previously.

Therefore, there is a need for a user equipment (UE) and a resource allocation method, which can solve issues in the related art, avoid transmission collision, provide a good communication performance, and/or provide high reliability.

### SUMMARY

The present disclosure relates to the field of communication systems, and more particularly, to a user equipment (UE) and a resource allocation method in sidelink (SL) communication.

In a first aspect of the present disclosure, a resource allocation method in sidelink communication by a user equipment (UE) includes determining, by a physical layer of the UE, a resource selection window in a sidelink resource pool, determining, by the physical layer of the UE, a contiguous partial sensing window, and switching, by the physical layer of the UE, a resource allocation in the sidelink resource pool between a contiguous partial sensing and a random-based resource selection.

In a second aspect of the present disclosure, a user equipment (UE) includes a memory for storing computer-executable instructions, a transceiver, and a processor coupled to the memory and the transceiver. The processor is configured to invoke and run the computer-executable instructions stored in the memory, to perform operations of: determining, by a physical layer of the UE, a resource selection window in a sidelink resource pool, determining, by the physical layer of the UE, a contiguous partial sensing window, and switching, by the physical layer of the UE, a resource allocation in the sidelink resource pool between a contiguous partial sensing and a random-based resource selection.

In a third aspect of the present disclosure, a non-transitory machine-readable storage medium has stored thereon instructions that, when executed by a computer, cause the computer to perform the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of user equipments (UEs) of communication in a communication network system according to an embodiment of the present disclosure.

FIG. 2 is a schematic diagram illustrating a user plane protocol stack according to an embodiment of the present disclosure.

FIG. 3 is a schematic diagram illustrating a control plane protocol stack according to an embodiment of the present disclosure.

FIG. 4 is a flowchart illustrating a resource allocation method in sidelink communication by a user equipment (UE) according to an embodiment of the present disclosure.

FIG. 5 is a schematic diagram illustrating an exemplary illustration of insufficient periodic-based partial sensing and contiguous partial sensing opportunities and results in a sidelink (SL) resource pool that allows both periodic and aperiodic transmissions according to an embodiment of the present disclosure.

FIG. 6 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

In the development of 5th generation-new radio (5G-NR) based sidelink communication system, the radio technology was primarily designed to support autonomous driving, vehicle platooning and extended sensor sharing use cases in advanced vehicle-to-everything (V2X) communication, and for which a communicating user equipment (UE) can assume to have unlimited supply of electrical power (i.e., connected to vehicle's battery). As such, it allows and is expected that a sidelink (SL) UE to receive and monitor SL radio channel(s) all the time for driving related messages to maintain road safety. Besides the data reception, a NR sidelink UE also transmits its own driving messages just as other surrounding V2X UEs to maintain road safety and keep traffic flow efficiently. In order to avoid collisions among SL transmitting UEs, a UE that has a data packet to transmit is required to perform sensing of SL resources on the radio channel to determine their reservation status/usage (e.g., whether it is already reserved by another UE and the interference level) before selecting one or more appropriate resources for its own transmission (Tx). Since a V2X UE with unlimited supply of power is receiving data messages all the time, it is reasonable to expect that the UE has full sensing results of the SL channel whenever it has a data message to transmit.

In the future, the use of 5G-NR sidelink technology will expand to areas other than just V2X, such as pedestrian-to-everything (P2X) communication for vulnerable road users (VRUs) like the pedestrians and bike riders/helmets, augmented reality (AR)/virtual reality (VR) glasses connecting to smartphones or a central node, backpack units for public safety emergency personnel to communicate with each other without cellular network signal, robots, unmanned oriel vehicles (UAVs), etc. In order to reduce the amount of necessary processing power for these battery operated/power constrained UEs, restricted monitoring of radio resources on a SL channel within a limited time duration in a pre-defined manner (as known as partial sensing) may be introduced in the next 3rd generation partnership project (3GPP) release/version of 5G-NR sidelink (e.g., 3GPP Release 17).

The main trigger for a UE to perform partial sensing/monitoring of a SL channel can be based on its need to transmit a data message over the SL. In some cases, however, due to unpredictable resource (re-)selection trigger timing from a certain type of SL traffic, operating scenario and resource re-selection triggering conditions, the UE is unable to perform monitoring of SL resource usage and obtain resource reservation information in advanced to gain sufficient pre-sensing results from partial sensing schemes such as periodic-based partial sensing and contiguous partial sensing. Without these pre-sensing results, the UE may be subsequently unable to detect and determine which of future SL resources that have already been periodically or dynamically reserved by other UEs. If a transmission (Tx) UE mistakenly selects a SL resource that has already been reserved but undetected by the Tx UE, SL transmission using the selected resource may cause a Tx collision with the UE that reserved this resource previously.

In some embodiments, for the present inventive method of resource allocation for SL communication, it aims to mitigate the above problem of transmission collision resulting from lacking of pre-sensing results available during a resource (re-)selection procedure due to unpredictable arrival of SL data packets for transmission by dynamically switching UE's resource allocation mechanism from a partial sensing-based scheme to a random-based resource selection. Other benefits of adopting the newly invented resource allocation mechanism may include further power saving and earlier transmission to reduce latency from not performing partial sensing at all, and potentially better reliability performance with active Tx collision avoidance from other UEs performing sensing.

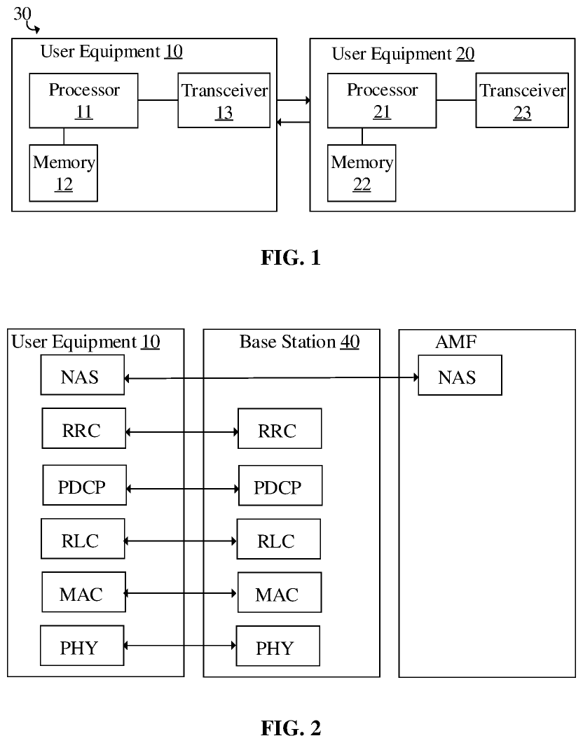

FIG. 1 illustrates that, in some embodiments, one or more user equipments (UEs) 10 (such as a first UE) and one or more user equipments (UEs) 20 (such as a second UE) of communication in a communication network system 30 according to an embodiment of the present disclosure are provided. The communication network system 30 includes one or more UEs 10 and one or more UE 20. The UE 10 may include a memory 12, a transceiver 13, and a processor 11 coupled to the memory 12 and the transceiver 13. The UE 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21 and transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) long term evolution (LTE) and new radio (NR) Release 17 and beyond. UEs are communicated with each other directly via a sidelink interface such as a PC5 interface. Some embodiments of the present disclosure relate to sidelink communication technology in 3GPP NR release 17 and beyond, for example providing cellular-vehicle to everything (C-V2X) communication.

In some embodiments, the UE 10 may be a sidelink packet transport block (TB) transmission UE (Tx-UE). The UE 20 may be a sidelink packet TB reception UE (Rx-UE) or a peer UE. The sidelink packet TB Rx-UE can be configured to send ACK/NACK feedback to the packet TB Tx-UE. The peer UE 20 is another UE communicating with the Tx-UE 10 in a same SL unicast or groupcast session.

FIG. 2 illustrates an example user plane protocol stack according to an embodiment of the present disclosure. FIG. 2 illustrates that, in some embodiments, in the user plane protocol stack, where service data adaptation protocol (SDAP), packet data convergence protocol (PDCP), radio link control (RLC), and media access control (MAC) sublayers and physical (PHY) layer may be terminated in a UE 10 and a base station 40 (such as gNB) on a network side. In an example, a PHY layer provides transport services to higher layers (e.g., MAC, RRC, etc.). In an example, services and functions of a MAC sublayer may comprise mapping between logical channels and transport channels, multiplexing/demultiplexing of MAC service data units (SDUs) belonging to one or different logical channels into/from transport blocks (TB s) delivered to/from the PHY layer, scheduling information reporting, error correction through hybrid automatic repeat request (HARQ) (e.g. one HARQ entity per carrier in case of carrier aggregation (CA)), priority handling between UEs by means of dynamic scheduling, priority handling between logical channels of one UE by means of logical channel prioritization, and/or padding. A MAC entity may support one or multiple numerologies and/or transmission timings. In an example, mapping restrictions in a logical channel prioritization may control which numerology and/or transmission timing a logical channel may use. In an example, an RLC sublayer may supports transparent mode (TM), unacknowledged mode (UM) and acknowledged mode (AM) transmission modes. The RLC configuration may be per logical channel with no dependency on numerologies and/or transmission time interval (TTI) durations. In an example, automatic repeat request (ARQ) may operate on any of the numerologies and/or TTI durations the logical channel is configured with. In an example, services and functions of the PDCP layer for the user plane may comprise sequence numbering, header compression, and decompression, transfer of user data, reordering and duplicate detection, PDCP PDU routing (e.g., in case of split bearers), retransmission of PDCP SDUs, ciphering, deciphering and integrity protection, PDCP SDU discard, PDCP re-establishment and data recovery for RLC AM, and/or duplication of PDCP PDUs. In an example, services and functions of SDAP may comprise mapping between a QoS flow and a data radio bearer. In an example, services and functions of SDAP may comprise mapping quality of service Indicator (QFI) in downlink (DL) and uplink (UL) packets. In an example, a protocol entity of SDAP may be configured for an individual PDU session.

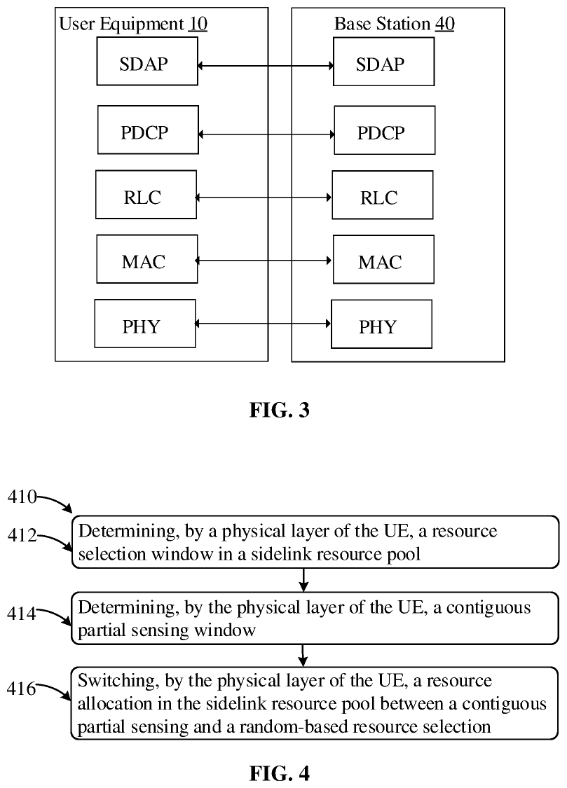

FIG. 3 illustrates an example control plane protocol stack according to an embodiment of the present disclosure. FIG. 3 illustrates that, in some embodiments, in the control plane protocol stack where PDCP, RLC, and MAC sublayers and PHY layer may be terminated in a UE 10 and a base station 40 (such as gNB) on a network side and perform service and functions described above. In an example, RRC used to control a radio resource between the UE and a base station (such as a gNB). In an example, RRC may be terminated in a UE and the gNB on a network side. In an example, services and functions of RRC may comprise broadcast of system information related to AS and NAS, paging initiated by 5GC or RAN, establishment, maintenance and release of an RRC connection between the UE and RAN, security functions including key management, establishment, configuration, maintenance and release of signaling radio bearers (SRBs) and data radio bearers (DRBs), mobility functions, QoS management functions, UE measurement reporting and control of the reporting, detection of and recovery from radio link failure, and/or non-access stratum (NAS) message transfer to/from NAS from/to a UE. In an example, NAS control protocol may be terminated in the UE and AMF on a network side and may perform functions such as authentication, mobility management between a UE and an AMF for 3GPP access and non-3GPP access, and session management between a UE and a SMF for 3GPP access and non-3GPP access.

When a specific application is executed and a data communication service is required by the specific application in the UE, an application layer taking charge of executing the specific application provides the application-related information, that is, the application group/category/priority information/ID to the NAS layer. In this case, the application-related information may be pre-configured/defined in the UE. (Alternatively, the application-related information is received from the network to be provided from the AS (RRC) layer to the application layer, and when the application layer starts the data communication service, the application layer requests the information provision to the AS (RRC) layer to receive the information.)

In some embodiments, the physical layer of the UE 10 or 20 is configured to determine a resource selection window in a sidelink resource pool, determine a contiguous partial sensing window, and switch a resource allocation in the sidelink resource pool between a contiguous partial sensing and a random-based resource selection. This can solve issues in the related art, avoid transmission collision, provide a good communication performance, and/or provide high reliability.

FIG. 4 illustrates a resource allocation method 410 in sidelink communication by a user equipment (UE) according to an embodiment of the present disclosure. In some embodiments, the method 410 includes: a block 412, determining, by a physical layer of the UE, a resource selection window in a sidelink resource pool, a block 414, determining, by the physical layer of the UE, a contiguous partial sensing window, and a block 416, switching, by the physical layer of the UE, a resource allocation in the sidelink resource pool between a contiguous partial sensing and a random-based resource selection. This can solve issues in the related art, avoid transmission collision, provide a good communication performance, and/or provide high reliability.

In some embodiments, switching, by the physical layer of the UE, the resource allocation between the contiguous partial sensing and the random-based resource selection comprises dynamically switching, by the physical layer of the UE, the resource allocation from the contiguous partial sensing to the random-based resource selection. In some embodiments, if a time interval of the contiguous partial sensing window is less than X, the physical layer of the UE switches the resource allocation in the sidelink resource pool between the contiguous partial sensing and the random-based resource selection, where X is a configured minimum sensing time interval for contiguous partial sensing. In some embodiments, if a parameter for the sidelink resource pool is configured as disabled, the physical layer of the UE switches the resource allocation in the sidelink resource pool between the contiguous partial sensing and the random-based resource selection.

In some embodiments, the parameter comprises sl-MultiReserveResource. In some embodiments, if the sidelink resource pool allows only aperiodic transmission, the physical layer of the UE switches the resource allocation in the sidelink resource pool between the contiguous partial sensing and the random-based resource selection. In some embodiments, the sidelink resource pool is provided by a higher layer of the UE. In some embodiments, the physical layer of the UE based on its implementation to either continue the contiguous partial sensing or perform the random-based resource selection. In some embodiments, the method further comprises determining, by the physical layer of the UE, if the physical layer of the UE has sufficient sensing results for determining the resource selection window based on the contiguous partial sensing using at least one threshold criterion.

In some embodiments, the at least one threshold criterion comprises that: configured slots out of candidate slots from a periodic-based partial sensing are within the resource selection window, and/or the time interval of the contiguous partial sensing window from the contiguous partial sensing is at least X slots. In some embodiments, if the at least one threshold criterion is not met, the physical layer of the UE switches the resource allocation in the sidelink resource pool between the contiguous partial sensing and the random-based resource selection by reporting a full set or an empty set of candidate resources to the higher layer. In some embodiments, the higher layer of the UE is configured to randomly select a time and frequency resource from reported subset of resources indicated by a physical layer for physical sidelink shared channel (PSSCH) transmission or physical sidelink control channel (PSCCH) transmission.

In some embodiments, if the physical layer of the UE reports the empty set of candidate resources to the higher layer, the higher layer of the UE randomly determines and/or selects a set of resources according to a required number of resources and/or a required resource size in number of sub-channels to be used for the PSSCH transmission or the PSCCH transmission in a slot. In some embodiments, in either a random selection or determination of resources in the higher layer of the UE, the random selection ensures a minimum time gap between any two selected resources in case that a physical sidelink feedback channel (PSFCH) is configured for the sidelink resource pool and that a resource can be indicated by a time resource assignment of a prior sidelink control information (SCI) for a retransmission. In some embodiments, a parameter field for indicating random selection is turned on or set to true in the SCI for the PSCCH transmission.

In some embodiments, in the present disclosure of an inventive sidelink (SL) resource allocation and/or transmission scheme, intended primarily to be used by a power constrained SL transmission user equipment (Tx UE), when the UE physical layer is requested/triggered by its higher layer in slot n to report a subset of resources for selection as part of resource allocation mode 2 for physical sidelink shared channel (PSSCH)/physical sidelink control channel (PSCCH) transmission and it is further configured by its higher layer to performed partial sensing, the following method steps/principles are proposed and to be adopted by the SL transmitter UE.

When a number of candidate slots and/or sensing slots within a resource selection window for which sensing results are available is less than a certain threshold value(s), then UE transmission resource(s) cannot be selected based on partial sensing and it can be switched to random resource selection, by reporting a full set or an empty set of candidate resources to the higher layer for the random selection. The certain threshold value(s) may be the minimum M value from sl-CPS-WindowAperiodic.

In some embodiments, in a common case of periodic sidelink traffic transmission, the trigger timing slot (n) for SL resource (re-)selection is normally predictable and the packet delay budget (PDB) for radio transmission is typically constant/unchanged. As such, a set of Y candidate slots within a resource selection window [n+T₁, n+T₂] and a sensing window [n+T_{A}, n+T_{B}] can be pre-selected by the UE for periodic-based partial sensing and contiguous partial sensing, respectively, such that the UE always has sufficient opportunities to perform these partial sensing schemes in advanced to obtain all necessary pre-sensing results for selecting appropriate/unreserved resources in order to minimize the chance of transmission collision.

On the other hand, there are also other traffic type and operating scenarios in which the resource (re-)selection trigging timing cannot always be predictable or known in advanced. For example, data traffic arrival for aperiodic transmission and even for periodic traffic the generation of the very first medium access control (MAC) packet data unit (PDU)/transport block (TB) for SL transmission are unpredictable and they may come at random time. Furthermore, in case when re-selection of SL resources is triggered due to change of priority, packet size, transmission periodicity, PDB, or transmission dropping due to prioritization between SL/UL or SL/SL, the timing of these changes or events are also not known to the UE in advanced due to merge with other SL data traffic or UL scheduling from a serving base station.

In order to resolve this unpredictability of data traffic arrival and generation for SL transmission, and potentially causing Tx collisions in other UEs' reserved resources due to lacking of sensing results, it is proposed to switch the resource (re-)selection scheme configured by higher layer from partial sensing to random selection by reporting a full set or an empty set of candidate resources to the higher layer if number of candidate slots and/or sensing slots within a resource selection window (RSW) for which sensing results are available is less than a certain value(s). By switching to random resource selection, the UE further indicate using 1^{st} stage sidelink control information (SCI) to other UEs that the assigned/reserved time and frequency resources (also indicated in the 1^{st} stage SCI) are selected randomly, so that other UEs may re-select their resources if transmission collision with randomly selected UE is detected.

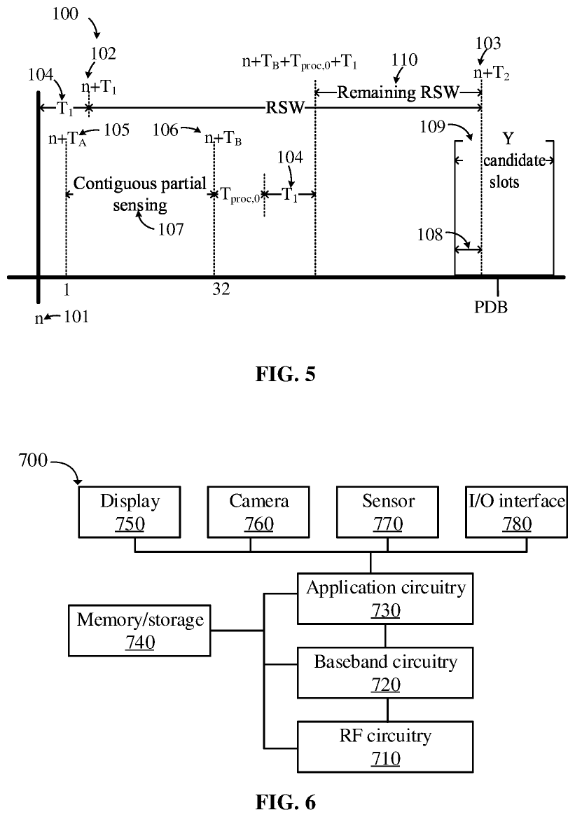

As an example of the proposed method for resource allocation scheme switching and transmission in SL communication, one or more of the following exemplary steps are explained in conjunction with an exemplary illustration in diagram 100 of FIG. 5 may be adopted. In some embodiments, if a UE (physical layer) is triggered in slot n (101) to report a subset of resources to the higher layer in resource allocation mode 2 for resource (re-)selection and partial sensing is configured by higher layer, then one or more of the following steps are used to determine and report the subset of resources for selection and transmission when the provided resource pool is also configured to allow random resource selection.

Step 1: UE determines a resource selection window (RSW) for a time interval between n+T₁ (102) and n+T₂ (103), where T₁ (104) is selected by UE implementation according to 0≤T₁≤T_{proc,1}^{SL} and T_{proc,1}^{SL} denotes a UE processing time to prepare PSCCH/PSSCH for SL transmission with a minimum value of 3 slots. T₂ is also selected by UE implementation according to T₂ₘᵢₙ≤T₂≤remaining packet delay budget (PDB) of the MAC PDU or TB, and T₂ₘᵢₙ defines a minimum time length for the RSW with a value range between 1 slot for 15 kHz sub-carrier spacing (SCS) and 160 slots for 120 kHz SCS.

Step 2: UE based on its implementation determines a sensing window [n+T_{A}, n+T_{B}] (105, 106) for performing a contiguous partial sensing of up to 32 slots (107) to detect dynamic resource assignments/reservations from other UEs within the said sensing window by decoding PSCCH and measuring RSRP in these slots. T_{A} and T_{B} are selected up to UE implementation under the conditions that T_{A}≥0 and 0≤T_{B}−T_{A}≤31 slots.

Step 3: A set S_{A} is initialized to a set of all the candidate single-slot resources of Y candidate slots within the RSW (between n+T₁ (102) and n+T₂ (103)) or the set S_{A} is an empty set for any one of the following exemplary cases.

Case 1: For a higher layer provided resource pool which allows both periodic and aperiodic transmissions (i.e., when a parameter sl-MultiReserveResource for the resource pool is configured as “enabled”), if the UE is performing periodic-based partial sensing (e.g., there is an on-going periodic-based partial sensing for the same or different MAC PDU or TB), the number of slots (108) from the Y candidate slots (109) of the periodic-based partial sensing located within a remaining RSW [n+T_{B}+T_{proc,0}^{SL}+T₁, n+T₂] (110) is less than a configured Y in value, and/or T_{B}−T_{A}<X for the contiguous partial sensing.

Case 2: For a higher layer provided resource pool which allows both periodic and aperiodic transmissions (i.e., when a parameter sl-MultiReserveResource for the resource pool is configured as “enabled”), if the UE is NOT performing periodic-based partial sensing (e.g., there is no on-going periodic-based partial sensing for the same or different MAC PDU or TB) and T_{B}−T_{A}<X for the contiguous partial sensing.

Case 3: For a higher layer provided resource pool which allows only aperiodic transmission (i.e., when a parameter sl-MultiReserveResource for the resource pool is configured as “disabled”) and T_{B}−T_{A}<X for the contiguous partial sensing, where T_{B}−T_{A} is the CPS window, where X is a configured minimum sensing time interval for contiguous partial sensing and T_{proc,0}^{SL} is a UE processing time set aside for computing sensing results from the contiguous partial sensing and periodic-based partial sensing (if any). X may be the minimum M value from sl-CPS-WindowAperiodic.

Step 4: UE reports the set S_{A} to higher layer (as a subset of resources from the physical layer).

Step 5: The higher layer (i.e., MAC layer) randomly selects time and frequency resource from the reported subset of resources indicated by the physical layer for the PSSCH/PSCCH transmission. If the reported resource set from the physical layer is an empty set, the MAC higher layer randomly determines/selects a set of resources according to a required number of resources needed for the selection/transmission, a required resource size (L_{subcH}) in number of sub-channels to be used for the PSSCH/PSCCH transmission in a slot, and within the remaining PDB of the MAC PDU or TB. The final selection of resources can ensure the minimum time gap between any two selected resources in case that PSFCH is configured for the resource pool and that a resource can be indicated by the time resource assignment of a prior SCI for a retransmission.

Step 6: Subsequently, during the PSSCH/PSCCH transmission, a parameter field for indicating “random selection” is turned ON/set to TRUE in the 1^{st} stage sidelink control information (SCI), to indicate that the announced/reserved resources are selected base on random selection.

In order to resolve the unpredictability of data traffic arrival for SL transmission, and potentially causing Tx collisions in other UEs' reserved resources due to lacking sensing results, the UE cannot perform resource selection based on partial sensing. Instead, the UE can switch to random resource selection by reporting from the physical layer to higher layer a full set or an empty set of candidate resources, when a number of candidate slots and/or sensing slots within a resource selection window for which sensing results are available is less than a certain threshold value(s). In details, in some embodiments, the key aspects of the innovation that lead to improving the deficiency of the partial sensing based resource selection scheme includes as follows.

Determine if UE (PHY layer) has sufficient sensing results for the resource (re-)selection procedure based on partial sensing using at least one minimum threshold criterion. At least one minimum threshold criterion could be configured Yₘᵢₙ slots out of Y candidate slots from a periodic-based partial sensing are located/included within a resource selection window (RSW), and/or a sensing window length (T_{B}−T_{A}) from a contiguous partial sensing can be at least X slots.

Switch to random-based resource selection scheme (also known as random resource selection or just random selection) when the at least one threshold criterion is not met, by reporting a full set or an empty set of candidate resources (S_{A}) to the higher layer.

The UE higher layer (e.g., medium access control MAC layer) randomly selects time and frequency resource from the reported subset of resources indicated by the physical layer for the physical sidelink shared channel (PSSCH)/physical sidelink control channel (PSCCH) transmission. If the reported resource set from the physical layer is an empty set, the MAC higher layer randomly determines/selects a set of resources according to a required number of resources needed for the selection/transmission, a required resource size (L_{subCH}) in number of sub-channels to be used for the PSSCH/PSCCH transmission in a slot, and within the remaining PDB of the MAC PDU or TB. In either the random selection or determination of resources in the MAC higher layer, the selection can also ensure the minimum time gap between any two selected resources in case that physical sidelink feedback channel (PSFCH) is configured for the resource pool and that a resource can be indicated by the time resource assignment of a prior sidelink control information (SCI) for a retransmission.

Subsequently, a parameter field for indicating “random selection” is turned ON/set to TRUE in sidelink control information (SCI) for the PSCCH transmission, such that other UEs may actively avoid transmission collision in the indicated resources when performing resource re-evaluation or pre-emption checking.

Commercial interests for some embodiments are as follows. 1. Solving issues in the related art. 2. Avoiding transmission collision. 3. Providing good communication performance. 4. Providing high reliability. 5. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, smart watches, wireless earbuds, wireless headphones, communication devices, remote control vehicles, and robots for public safety use, AR/VR device maker for example gaming, conference/seminar, education purposes, smart home appliances including TV, stereo, speakers, lights, door bells, locks, cameras, conferencing headsets, and etc., smart factory and warehouse equipment including IIoT devices, robots, robotic arms, and simply just between production machines. In some embodiments, commercial interest for the disclosed invention and business importance includes lowering power consumption for wireless communication means longer operating time for the device and/or better user experience and product satisfaction from longer operating time between battery charging. Some embodiments of the present disclosure are a combination of “techniques/processes” that can be adopted in 3GPP specification to create an end product. Some embodiments of the present disclosure relate to mobile cellular communication technology in 3GPP NR Release 17 and beyond for providing direct device-to-device (D2D) wireless communication services.

FIG. 6 is a block diagram of an example system 700 for wireless communication according to an embodiment of the present disclosure. Embodiments described herein may be implemented into the system using any suitably configured hardware and/or software. FIG. 6 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network.

In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, a AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations cannot go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A resource allocation method in sidelink communication by a user equipment (UE), comprising:
determining, by a physical layer of the UE, a resource selection window in a sidelink resource pool;
determining, by the physical layer of the UE, a contiguous partial sensing window; and
switching, by the physical layer of the UE, a resource allocation in the sidelink resource pool between a contiguous partial sensing and a random-based resource selection.

2. The method of claim 1, wherein switching, by the physical layer of the UE, the resource allocation between the contiguous partial sensing and the random-based resource selection comprises:
dynamically switching, by the physical layer of the UE, the resource allocation from the contiguous partial sensing to the random-based resource selection.

3. The method of claim 1, wherein if a time interval of the contiguous partial sensing window is less than X, the physical layer of the UE switches the resource allocation in the sidelink resource pool between the contiguous partial sensing and the random-based resource selection, where X is a configured minimum sensing time interval for contiguous partial sensing.

4. The method of claim 1, wherein if a parameter for the sidelink resource pool is configured as disabled, the physical layer of the UE switches the resource allocation in the sidelink resource pool between the contiguous partial sensing and the random-based resource selection.

5. The method of claim 4, wherein the parameter comprises sl-MultiReserveResource.

6. The method of claim 1, wherein if the sidelink resource pool allows only aperiodic transmission, the physical layer of the UE switches the resource allocation in the sidelink resource pool between the contiguous partial sensing and the random-based resource selection.

7. The method of claim 1, wherein the sidelink resource pool is provided by a higher layer of the UE.

8. The method of claim 1, wherein the physical layer of the UE based on its implementation to either continue the contiguous partial sensing or perform the random-based resource selection.

9. The method of claim 3, further comprising determining, by the physical layer of the UE, if the physical layer of the UE has sufficient sensing results for determining the resource selection window based on the contiguous partial sensing using at least one threshold criterion.

10. The method of claim 9, wherein the at least one threshold criterion comprises at least one of: configured slots out of candidate slots from a periodic-based partial sensing are within the resource selection window, or
the time interval of the contiguous partial sensing window from the contiguous partial sensing is at least X slots.

11. The method of claim 9, wherein if the at least one threshold criterion is not met, the physical layer of the UE switches the resource allocation in the sidelink resource pool between the contiguous partial sensing and the random-based resource selection by reporting a full set or an empty set of candidate resources to the higher layer.

12. The method of claim 11, wherein the higher layer of the UE is configured to randomly select a time and frequency resource from reported subset of resources indicated by a physical layer for physical sidelink shared channel (PSSCH) transmission or physical sidelink control channel (PSCCH) transmission.

13. The method of claim 12, wherein if the physical layer of the UE reports the empty set of candidate resources to the higher layer, the higher layer of the UE randomly determines and/or selects a set of resources according to at least one of: a required number of resources or a required resource size in number of sub-channels to be used for the PSSCH transmission or the PSCCH transmission in a slot.

14. The method of claim 8, wherein in either a random selection or determination of resources in the higher layer of the UE, the random selection ensures a minimum time gap between any two selected resources in case that a physical sidelink feedback channel (PSFCH) is configured for the sidelink resource pool and that a resource can be indicated by a time resource assignment of a prior sidelink control information (SCI) for a retransmission.

15. The method of claim 12, wherein a parameter field for indicating random selection is turned on or set to true in the SCI for the PSCCH transmission.

16. A user equipment (UE), comprising:
a memory for storing computer-executable instructions; and
a processor coupled to the memory;
wherein the processor is configured to invoke and run the computer-executable instructions stored in the memory, to perform operations of:
determining, by a physical layer of the UE, a resource selection window in a sidelink resource pool;
determining, by the physical layer of the UE, a contiguous partial sensing window; and
switching, by the physical layer of the UE, a resource allocation in the sidelink resource pool between a contiguous partial sensing and a random-based resource selection.

17. The UE of claim 16, wherein switching, by the physical layer of the UE, the resource allocation between the contiguous partial sensing and the random-based resource selection comprises:
dynamically switching, by the physical layer of the UE, the resource allocation from the contiguous partial sensing to the random-based resource selection.

18. The UE of claim 16, wherein if a time interval of the contiguous partial sensing window is less than X, the physical layer of the UE switches the resource allocation in the sidelink resource pool between the contiguous partial sensing and the random-based resource selection, where X is a configured minimum sensing time interval for contiguous partial sensing.

19. The UE of claim 16, wherein if a parameter for the sidelink resource pool is configured as disabled, the physical layer of the UE switches the resource allocation in the sidelink resource pool between the contiguous partial sensing and the random-based resource selection.

20. A non-transitory machine-readable storage medium having stored thereon instructions that, when executed by a computer, cause the computer to perform operations of:
determining, by a physical layer of a user equipment (UE), a resource selection window in a sidelink resource pool;
determining, by the physical layer of the UE, a contiguous partial sensing window; and
switching, by the physical layer of the UE, a resource allocation in the sidelink resource pool between a contiguous partial sensing and a random-based resource selection.
